(19) United States
(12) Patent Application Publication
(10) Pub. No.: US 2012/0155727 A1
(43) Pub. Date: Jun. 21, 2012

(54) METHOD AND APPARATUS FOR PROVIDING MOTION-COMPENSATED IMAGES

(75) Inventor: FREDRIK ORDERUD, OSLO (NO)

(73) Assignee: GENERAL ELECTRIC COMPANY, SCHENECTADY, NY (US)

(21) Appl. No.: 12/968,765

(22) Filed: Dec. 15, 2010

(51) Int. Cl. G06K 9/00

(52) U.S. Cl. 382/131; 382/154

(57) ABSTRACT

A method for performing motion compensated temporal filtering of a three-dimensional (3D) image dataset includes accessing with a processor a three-dimensional (3D) dataset comprising a plurality of images, the images including at least a first 3D image acquired at a first time and a different second 3D mage acquired at a second time, determining a phase correlation between at least one patch in the first 3D image and at least one patch in the second 3D image, generating 3D displacement vectors that represents displacement between a patch in the first 3D image and the patch in the second 3D image, and generating at least one 3D image using one or more 3D displacement vectors. A non-transitory computer readable medium and an ultrasound imaging system are also described herein.

### BACKGROUND OF THE INVENTION

The subject matter disclosed herein relates generally to diagnostic imaging systems, and more particularly, to ultrasound imaging systems for identifying and correcting motion in an ultrasound image.

Medical imaging systems are used in different applications to image different regions or areas (e.g., different organs) of patients. For example, ultrasound imaging systems are finding use in an increasing number of applications, such as to generate images of moving structures within the patient. In some imaging applications, a plurality of images are acquired of the patient during an imaging scan at a predetermined frame rate, such as for example, 20 frames per second. However, it is often desirable to increase the quantity of images, i.e. increase the frame rate, to provide additional images of some physiological event.

An example of a physiological event that may benefit from a higher frame-rate is cardiac valve motion. At 20 frames per second, only a few images are available to study the opening of a valve. Therefore, it is desirable to increase the frame rate to provide additional images showing the motion of the valve. One method of improving the frame rate utilizes a conventional algorithm to average two images together to form an interim image. For example, to acquire 30 frames per second, the conventional algorithm averages two images together to generate an interim image. Thus, 20 images are averaged together, two images at a time, to generate 10 interim images, for a total of 30 images. The 30 images are then displayed for review and analysis by a user.

However, when the conventional algorithm is applied to three-dimensional (3D) images, the resulting interim images are often blurred. Specifically, the conventional algorithm does not compensate for motion between the two 3D images. Thus, the two 3D images that are used to form an interim 3D image may not be properly registered causing the interim 3D image to be blurry. To avoid blurring, motion between subsequent 3D images should be taken into account to generate a 3D interim image with reduced blurring. However, identification of the motion field between 3D ultrasound images has been considered very computationally expensive, and therefore is not currently implemented into existing ultrasound imaging systems.

### BRIEF DESCRIPTION OF THE INVENTION

In one embodiment, a method for performing motion compensated temporal filtering of a three-dimensional (3D) image dataset is provided. The method includes accessing with a processor a three-dimensional (3D) dataset comprising a plurality of images, the images including at least a first 3D image acquired at a first time and a different second 3D mage acquired at a second time, determining a phase correlation between one or more patches in the first 3D image and one or more patches in the second 3D image, generating 3D displacement vectors that represents a displacement between a patch in the first 3D image and a patch in the second 3D image, and generating at least one 3D image using one or more 3D displacement vectors. A non-transitory computer readable medium and an ultrasound imaging system are also described herein.

In another embodiment, a non-transitory computer readable medium is provided. The non-transitory computer readable medium is programmed to access a three-dimensional (3D) dataset including plurality of images, the images including at least a first 3D image acquired at a first time and a different second 3D mage acquired at a second time, determine a phase correlation between one or more patches in the first 3D image and one or more patches in the second 3D image, generate 3D displacement vectors that represents a displacement between a patch in the first 3D image and a patch in the second 3D image, and generate at least one 3D image using one or more 3D displacement vectors.

In a further embodiment, an ultrasound imaging system is provided. The ultrasound imaging system includes a probe and a processor coupled to the probe. The processor is programmed to access a three-dimensional (3D) dataset including plurality of images, the images including at least a first 3D image acquired at a first time and a different second 3D mage acquired at a second time, determine a phase correlation between one or more patches in the first 3D image and one or more patches in the second 3D image, generate 3D displacement vectors that represents a displacement between a patch in the first 3D image and a patch in the second 3D image, and generate at least one 3D image using one or more 3D displacement vectors.

### BRIEF DESCRIPTION OF THE DRAWINGS

FIG. 1 illustrates a simplified block diagram of an ultrasound imaging system that is formed in accordance with various embodiments.

FIG. 2 is a flowchart illustrating an exemplary method for determining the motion field between at least two 3D ultrasound images.

FIG. 3 is an exemplary image formed in accordance with various embodiments.

FIG. 4 is another exemplary image formed in accordance with various embodiments.

FIG. 5 is an exemplary image patch formed in accordance with various embodiments.

FIG. 7 is another exemplary image patch formed in accordance with various embodiments.

FIG. 8 is an exemplary deformation map formed in accordance with various embodiments.

FIG. 9 is another exemplary deformation map formed in accordance with various embodiments.

FIG. 10 is another exemplary deformation map formed in accordance with various embodiments.

FIG. 11 is a simplified block diagram of an exemplary 3D volume dataset formed in accordance with various embodiments.

FIG. 12 is a simplified block diagram of the exemplary 3D volume dataset shown in FIG. 11.

FIG. 13 illustrates a simplified block diagram of another ultrasound imaging system that is formed in accordance with various embodiments.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

At least one embodiment disclosed herein makes use of methods for automatically determining a motion field of a medical image in real-time. The motion field may then be utilized to generate interim images. At least one technical effect of some embodiments is a more computationally efficient method for correcting blurring. For example, the methods described herein are suitable for real-time implementation in a three-dimensional (3D) ultrasound imaging system.

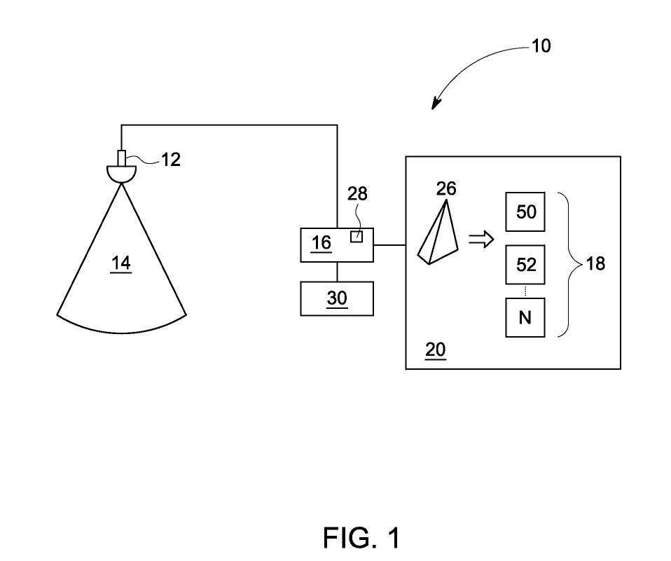

FIG. 1 illustrates a simplified block diagram of an exemplary ultrasound imaging system 10 that is formed in accordance with various embodiments. The ultrasound imaging system 10 includes an ultrasound probe 12 that is used to scan a region of interest (ROI) 14. A processor 16 processes the acquired ultrasound information received from the ultrasound probe 12 and prepares a plurality of display image frames 18 that may be displayed on a display 20. In the exemplary embodiment, two display frames or images 50 and 52 are displayed on the display 20. It should be realized that any quantity of image frames 18 may be displayed on the display 20. In the exemplary embodiment, each of the display images 18 represents either a slice through a 3D volume dataset 26 at a specific location, or a volume rendering. The 3D volume dataset 26 may be displayed concurrently with the display images 18. The ultrasound imaging system 10 also includes a frame processing module 28 that is programmed to automatically determine a motion field of a plurality of medical images in real-time and then generate interim images that may be combined with plurality of medical images to increase the frame rate of the imaging system 10.

The imaging system 10 also includes a user interface 30 that allows an operator to enter data, enter and change scanning parameters, access protocols, measure structures of interest, and the like. The user interface 30 also enables the operator to transmit and receive information to and/or from the frame processing module 28, that instructs the frame processing module 28 to perform the various methods described herein.

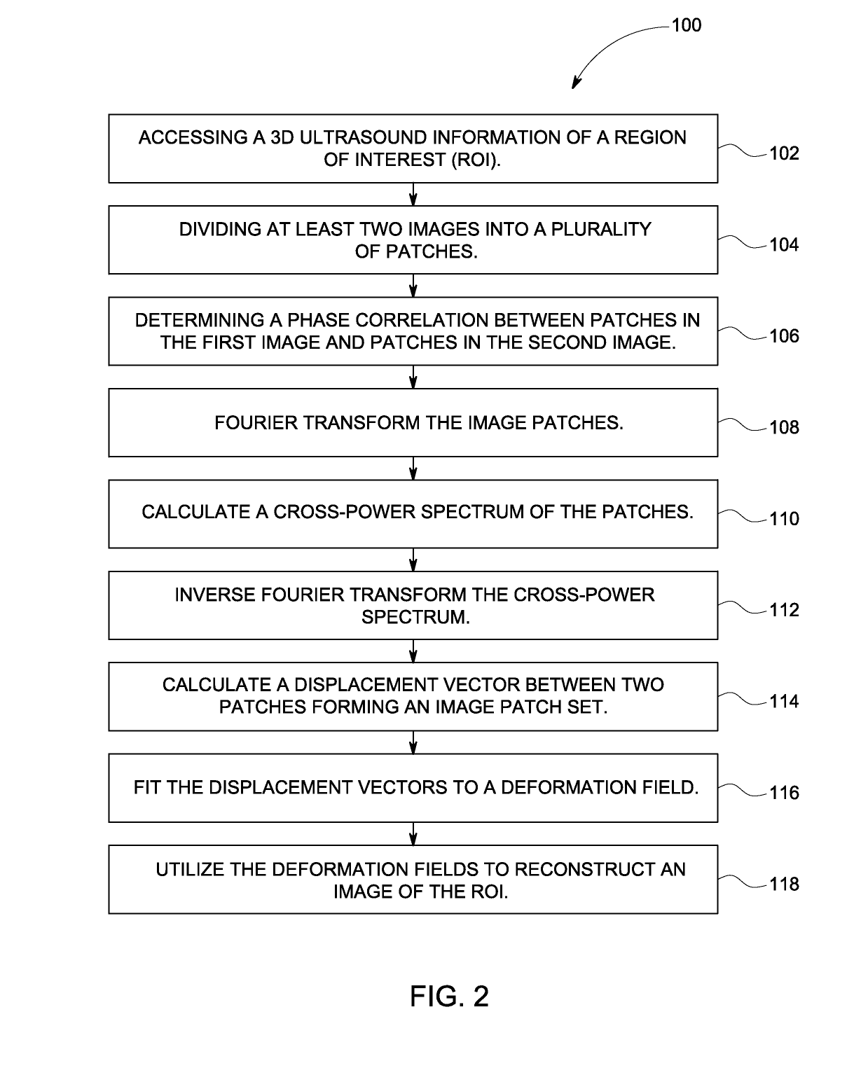

FIG. 2 is a flowchart illustrating a method 100 for determining the motion field between at least two 3D ultrasound images, such as the 3D images 50 and 52 shown in FIG. 1. It should be noted that although the method 100 is described in connection with ultrasound imaging having particular characteristics, the various embodiments described herein are not limited to ultrasound imaging or to any particular imaging characteristics. For example, although the method 100 is described in connection with 3D ultrasound images, any type of images may be utilized. In the exemplary embodiment, the method 100 may be implemented using the frame processing module 28 shown in FIG. 1.

The method 100 includes accessing at 102 with a processor, such as the processor 16, a 3D volume dataset, such as the 3D volume dataset 26, also shown in FIG. 1. In the exemplary embodiment, the 3D volume dataset 26 includes the sequence of N image frames 18. In one embodiment, the 3D volume dataset 26 may include grayscale data, scalar grayscale data, parameters or components such as color, displacement, velocity, temperature, material strain or other information or source of information that may be coded into an image. The image frames 18 may be acquired over the duration of a patient scan, for example. The quantity N of image frames 18 may vary from patient to patient and may depend upon the length of the individual patient's scan as well as the frame rate of the imaging system 10.

In the exemplary embodiment, the image frames 18 are acquired sequentially during a single scanning procedure. Therefore, the image frames 18 are of the same patient or object, but acquired at different times during the same scanning procedure. In the exemplary embodiment, the plurality of image frames 18 form the 3D ultrasound volume dataset that includes at least the first 3D image 50 acquired at a first time period, and the different second 3D image 52 (both shown in FIG. 1) acquired at a second different time period. It should be realized that in the exemplary embodiment, the 3D volume dataset includes more than the two 3D image frames 50 and 52 shown in FIG. 1.

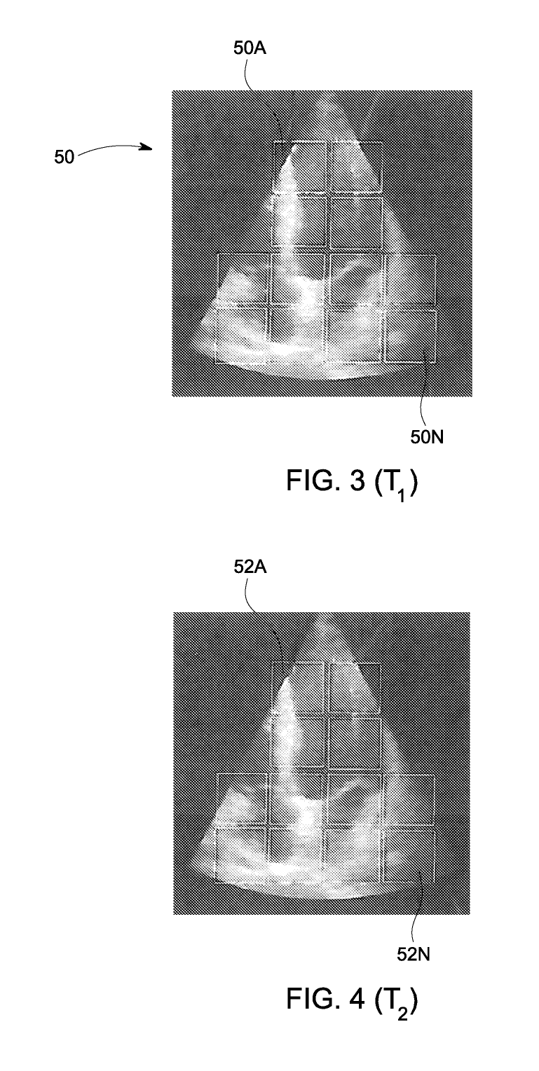

At 102, the image 50 and the image 52 are divided into a plurality of blocks or patches 50_{a . . . n} and 52_{a . . . n}, respectively, as shown in FIGS. 3 and 4. In the exemplary embodiment, the patches 50_{a . . . n} are substantially the same size, i.e. include the same number of pixels, as the patches 52_{a . . . n}. Moreover, the quantity of patches 50_{a . . . n} is the same as the quantity of patches 52_{a . . . n}, i.e. n=12, such that each patch 50_{a . . . n} within the first image 50 corresponds to a respective patch 52_{a . . . n} that is the same size and located in the same position in, x, z, and z, within the second image 52. A patch in the first image 50, for example patch 50ₐ, that corresponds with a patch in the second image 52, for example 52ₐ, is referred to herein as a “set” of image patches. Thus, one set of image patches includes patches 50ₐ and 52ₐ. A second set of patches includes patches 50_{b} and 52_{b}. A third set of patches includes patches 50ₐ and 52ₐ, etc. In the exemplary embodiment, because each of the images 50 and 52 is divided into twelve patches, there are a total of twelve sets of patches formed. It should also be realized that although the embodiment described herein describes and illustrates the images 50 and 52 being divided into twelve patches, that the images 50 and 52 may be divided into any quantity of patches, i.e. n>0. In the exemplary embodiment, a phase correlation algorithm may be utilized to divide the images into patches as described in more detail above.

At 104, a phase correlation is determined between the patches in each set of patches. For example, a phase correlation is determined between the patch 50ₐ in the image 50 and a respective patch 52ₐ in the image 52. In operation, a phase correlation is first determined between a patch 50ₐ in the image 50 and a respective patch 52ₐ in the image 52. It should be realized that although the phase correlation at step 104 is described with respect to a single set of image patches 50ₐ and 52ₐ, the phase correlation is applied to each of the sets of patches 50_{a . . . n} . . . 52_{a . . . n} in both images 50 and 52. In the exemplary embodiment, the phase correlation is a frequency-space technique for determining a translative motion between images frames, and more particularly, to determining a translative motion between each single patch 50_{a . . . n} in the image 50 and a respective patch 52_{a . . . n} in the image 52. The translative motion represents the displacement or movement, between an image patch 50_{a . . . n} in the image 50 and a respective image patch 52_{a . . . n} in the image 52.

In the exemplary embodiment, the phase correlation is based on a Fourier shift theorem that relates the translation in one domain to phase shifts in the other domain. Thus, by detecting the phase shift between two respective image patches, such as image patches 50ₐ and 52ₐ, the translative motion between the image patch 50ₐ in the image 50 and the image patch 52ₐ in the image 52, the motion between respective patches may be determined without performing any search of the images patches themselves.

For example, at 106, image patches 50ₐ and 52ₐ are Fourier Transformed. In the exemplary embodiment, a windowing function, may be applied to the image patches 50ₐ and 52ₐ prior to the Fourier Transform function to reduce edge artifacts. In the exemplary embodiment, the windowing function is a function that is zero-valued outside of some chosen interval.

At 108, a normalized cross-power spectrum R(u,v,w) is then calculated for the set of patches 50ₐ and 52ₐ using the Fourier Transformed image patches. The normalized cross-power spectrum refers to the translative motion, i.e. the displacement or movement, between the image patch 50ₐ and the image patch 52ₐ. For example, the normalized cross-power spectrum R(u,v,w) between the Fourier Transform of the image patches 52ₐ and 52_{b} is calculated in accordance with:

$$R ( u , v , w ) = \frac{{22}_{a} {24}_{a}}{\vert {22}_{a} {24}_{a} \vert} \qquad Equation 1$$

It should be realized that the normalized cross-power spectrum R(u,v,w) is calculated for each set of image patches at 108.

At 110, an inverse Fourier Transform (r_{x,y,z}) of the cross-power spectrum R(u,v,w) is calculated. In the exemplary embodiment, a windowing function may be applied to the cross-power spectrum R(u,v,w) prior to an inverse Fourier Transform function to facilitate suppressing the influence of noise in the high frequency components.

The inverse Fourier Transform of the cross-power spectrum R(u,v,w) is expressed as:

IFT(R(u,v,w))=r_{x,y,z} Equation 2

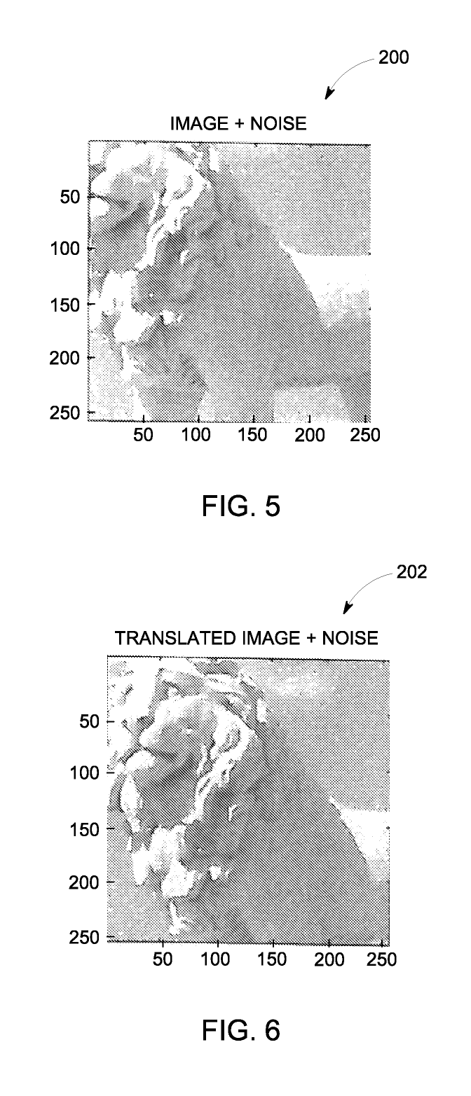

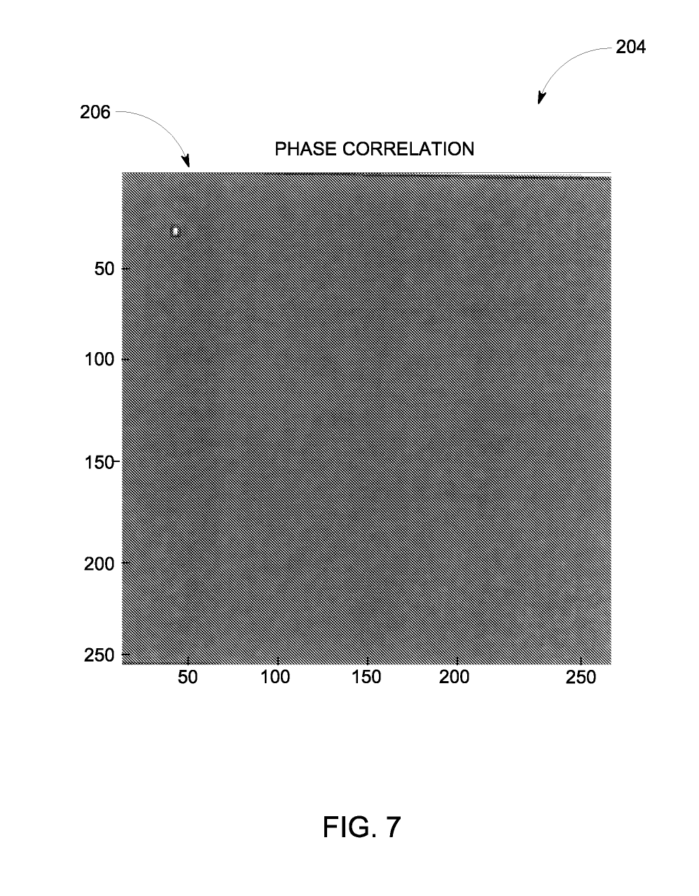

For example, FIGS. 5 and 6 represent two exemplary image patches 200 and 202, respectively, to illustrate usage of the phase-correlation technique in 2D images. As can be seen in FIGS. 4 and 5, the image patch 202 is translated or improperly aligned with respect to the image patch 200. Moreover, as shown in FIG. 7, an image 204 is the resultant image generated after the inverse Fourier Transform (r_{x,y,z}) of the cross-power spectrum of the two image patches 200 and 202 was calculated as discussed above. As shown in FIG. 7, the resulting displacement vector 206 between the two image patches 200 and 202 is shown as a bright white spot that is located proximate to the upper left corner of the image 204. The location of the white spot corresponds to a displacement vector, e.g. displacement vector 206. The displacement vector 206 having the highest intensity is utilized to align the two image patches 200 and 202. More generally, the displacement vector becomes a 3D vector that represents the translation of the image patch 200 with respect to the image patch 202 in x, y, and z coordinates when used on 3D images.

In the exemplary embodiment, at 112, a displacement vector, such as the displacement vector 206 shown in FIG. 7, is calculated between the image patch 50ₐ in the image 50 and the image patch 52ₐ in the image 52 by searching for coordinates within r_{x,y,z} having the strongest coefficients, i.e. having the highest intensity. In one embodiment, the displacement vector (disp) having the highest intensity may be identified in accordance with:

disp=arg max(r_{x,y,z}) Equation 3

Optionally, the displacement vector having the highest intensity within r_{x,y,z} may be identified on a sub-pixel level to improve accuracy and robustness as compared to determining the coefficients having the maximum value as described above. More specifically, the displacement vector having the highest intensity may be identified by calculating a circular center of gravity for r_{x,y,z} separably in x, y, and z in accordance with:

$${disp}_{x} - angle ( {\sum }_{x} {e}^{2 π i ( \frac{ux}{M} )} ( {\sum }_{v , w} {r}_{u , v , w} ) ) \\ {disp}_{y} - angle ( {\sum }_{y} {e}^{2 π i ( \frac{vy}{N} )} ( {\sum }_{u , w} {r}_{u , v , w} ) ) \\ {disp}_{z} - angle ( {\sum }_{z} {e}^{2 π i ( \frac{wz}{N} )} ( {\sum }_{u , v} {r}_{u , v , w} ) ) \qquad Equation 4$$

where disp_{x,y,z} are the x,y,z components of the displacement vector. In the exemplary embodiment, the coefficients outside of the area of maximum amplitude are suppressed to limit the effect of other non-maximum modes and background noise.

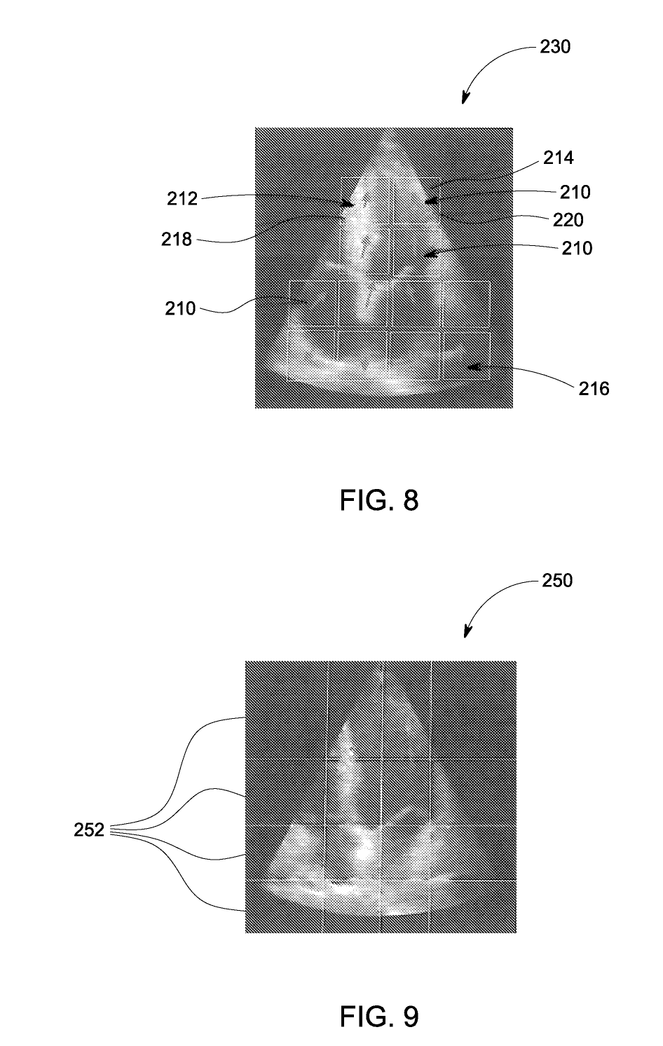

At 114, a displacement vector is calculated, for each set of image patches in the images 50 and 52 using Equation 4 described above. Therefore, because each of the exemplary images 50 and 52 is divided into twelve patches, there are twelve exemplary sets of patches formed. Twelve displacement vectors are therefore calculated for each set of image patches by iteratively repeating steps 106-114. It should be realized that the quantity of vectors is based upon the quantity of sets of patches. For example, FIG. 8 illustrates a deformation map 230 that includes the plurality of displacement vectors 210. For example, a displacement vector 212 represents a displacement between the patch 50ₐ and 52ₐ; a displacement vector 214 represents a displacement between the patch 50_{b} and 52_{b}; and a displacement vector 216 represents a displacement between the patch 50ₐ and 52ₙ. As discussed above, the exemplary embodiment illustrates twelve displacement vectors 210, however it should be realized the quantity of displacement vectors calculated is based on the quantity of sets of image patches.

At 116, each of the displacement vectors 210 calculated at 114 is fitted to a deformation field to generate a displacement value for each image pixel. For example, FIG. 8 is an exemplary deformation map 230 showing the displacement vector 212 fitted to a field 218 and the displacement vector 214 is fitted to a field 220. The deformation fields represent a motion and/or deformation of the object or voxel(s) of interest, such as the motion of the patch 50ₐ with respect to the patch and 52ₐ. The deformation fields may be formed, in one embodiment, by assuming that there is a constant displacement between the voxels in the patch 50ₐ and the patch 50_{b}. Optionally, the deformation field may be based on, for example, a spline or polygonal interpolation.

In one embodiment, the displacement vectors 210 calculated at 114 are fitted to a deformation field having a constant displacement within each patch. For example, FIG. 9 illustrates an exemplary deformation map 250 formed from a plurality of deformation fields 252.

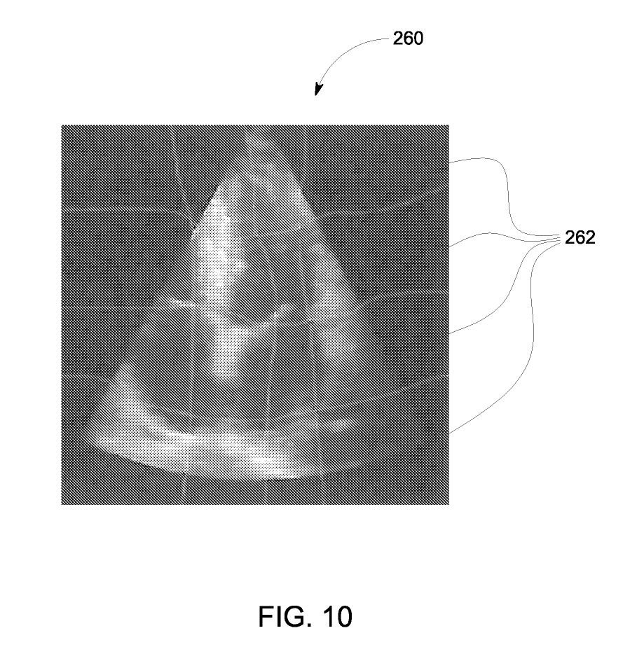

In another embodiment, the displacement vectors 210 calculated at 114 are fitted to a deformation field based on a polygonal interpolation, i.e. a weighted linear sum, or a spline grid. For example, FIG. 10 is an exemplary spline grid 260 that includes a plurality of deformation fields 262 that may be used to fit the displacement vectors 210. In the exemplary embodiment, the displacement vectors 210 may be fit to a deformation field using a direct or least squares fitting.

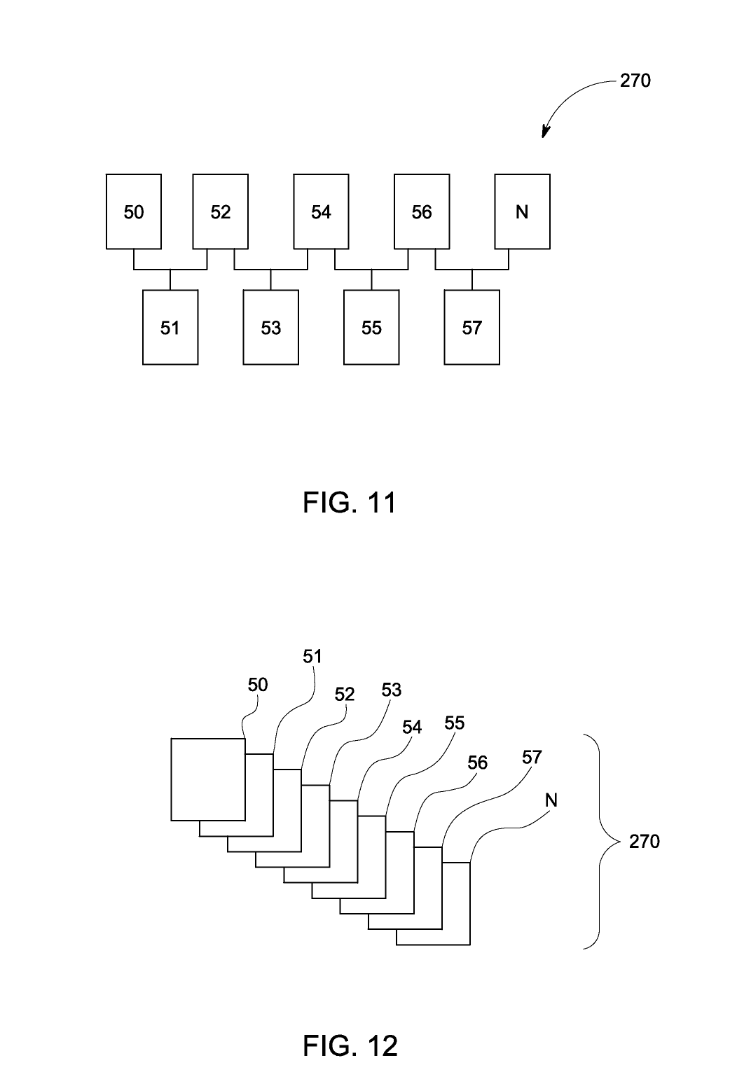

At 118, the deformation fields calculated at 116 are utilized to reconstruct an interim image 51 of the object. For example, FIG. 11 is a simplified block diagram representing an exemplary 3D image dataset 270 formed in accordance with various embodiments. The images 50 and 52 are used to generate the interim image 51 as discussed above in steps 102-118. After the interim image 51 has been generated, the next two images in the image sequence are utilized to generate another subsequent intermediate image. For example, the images 52 and 54 are utilized to generate an interim image 53; the images 54 and 56 are utilized to generate an interim image 55; the images 56 and N are utilized to generate an interim image 57, etc. In the exemplary embodiment, the methods described herein are applied iteratively to the initial 3D image 26 to form the plurality of interim images 51, 53, 55, 57 . . . n. The interim images are then combined with the initial images to form the 3D image dataset 270. In the exemplary embodiment, FIG. 12 is a simplified block diagram of the exemplary 3D image dataset 270 formed in accordance with various embodiments. In the exemplary embodiment, a single interim image, e.g. interim image 51, is interleaved or placed between a pair of initial images, e.g. images 50 and 52. As a result, the 3D image dataset 270 includes a plurality of interim images, wherein each interim image is disposed between a pair of initial images. Therefore, the combination of the initial images and the interim images provides a 3D image dataset 270 having a frame rate that is greater than the frame rate of the initial 3D image dataset 26.

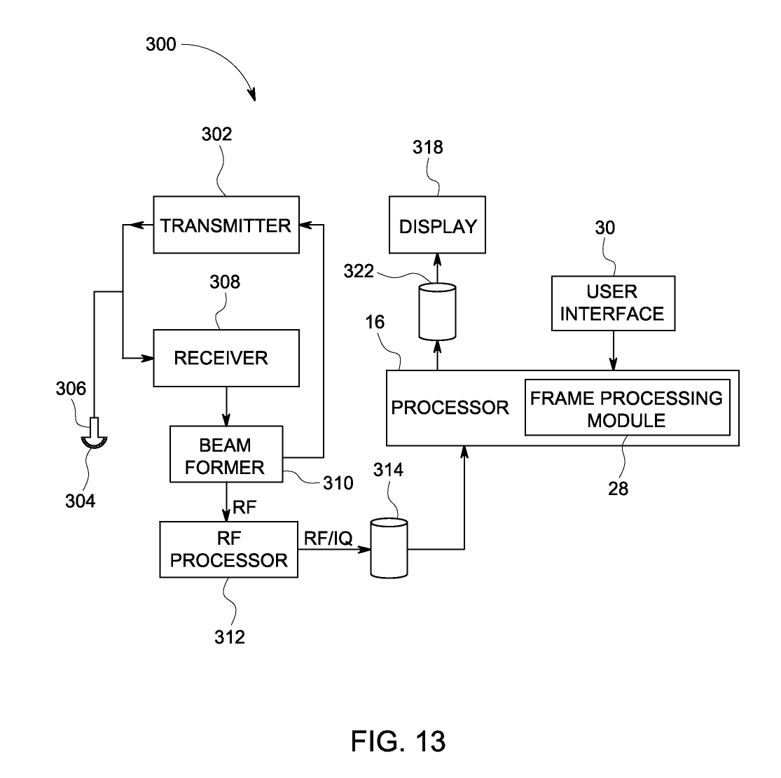

FIG. 13 is a block diagram of an ultrasound system 300 formed in accordance with various embodiments. The ultrasound system 300 may be configured to implement the various embodiments described. The ultrasound system 300 is capable of steering (mechanically and/or electronically) a acoustic beam in 3D space, and is configurable to acquire information corresponding to a plurality of two-dimensional (2D) or three-dimensional (3D) representations or images of a region of interest (ROI) in a subject or patient, such as ROI 14 shown in FIG. 1. The ultrasound system 300 is also configurable to acquire 2D and 3D images in one or more planes of orientation. In operation, real-time ultrasound imaging using a matrix or 3D ultrasound probe may be provided.

The ultrasound system 300 includes a transmitter 302 that, under the guidance of a beamformer 310, drives an array of elements 304 (e.g., piezoelectric elements) within a probe 306 to emit pulsed ultrasonic signals into a body. A variety of geometries may be used. The ultrasonic signals are back-scattered from structures in the body, like blood cells or muscular tissue, to produce echoes that return to the elements 304. The echoes are received by a receiver 308. The received echoes are passed through the beamformer 310, which performs receive beamforming and outputs an RF signal. The RF signal then passes through an RF processor 312. Optionally, the RF processor 312 may include a complex demodulator (not shown) that demodulates the RF signal to form IQ data pairs representative of the echo signals. The RF or IQ signal data may then be routed directly to a memory 314 for storage.

In the above-described embodiment, the beamformer 310 operates as a transmit and receive beamformer. In another embodiment, the probe 306 includes a 2D array with sub-aperture receive beamforming inside the probe. The beamformer 310 may delay, apodize and sum each electrical signal with other electrical signals received from the probe 306. The summed signals represent echoes from the ultrasound beams or lines. The summed signals are output from the beamformer 310 to the RF processor 312. The RF processor 312 may generate different data types, such as B-mode, color Doppler (velocity/power/variance), tissue Doppler (velocity), and Doppler energy, for one or more scan planes or different scanning patterns. For example, the RF processor 312 may generate tissue Doppler data for multiple (e.g., three) scan planes. The RF processor 312 gathers the information (e.g. I/Q, B-mode, color Doppler, tissue Doppler, and Doppler energy information) related to multiple data slices and stores the data information with time stamp and orientation/rotation information in the memory 314.

The ultrasound system 300 also includes the processor 16 and the frame processing module 28 that is programmed to automatically determine a motion field of a plurality of medical images in real-time and then generate interim images that may be combined with plurality of medical images to improve or increase the frame rate of the imaging system 300. The processor 16 is also configured to process the acquired ultrasound information (e.g., RF signal data or IQ data pairs) and prepare frames of ultrasound information for display on a display 318. The processor 16 is adapted to perform one or more processing operations according to a plurality of selectable ultrasound modalities on the acquired ultrasound data. Acquired ultrasound data may be processed and displayed in real-time during a scanning session as the echo signals are received. Additionally or alternatively, the ultrasound data may be stored temporarily in memory 314 during a scanning session and then processed and displayed in an off-line operation.

The processor 16 is connected to the user interface 30 that may control operation of the processor 16. The user interface 30 may include hardware components (e.g., keyboard, mouse, trackball, etc.), software components (e.g., a user display) or a combination thereof. The processor 16 also includes the phase correlation module 26 that performs motion correcting on acquired ultrasound images and/or generates interim ultrasound images for display, which in some embodiments are displayed as a 3D images on a display 318.

The display 318 includes one or more monitors that present the ultrasound images to the user for diagnosis and analysis. One or both of the memory 314 and the memory 322 may store 3D data sets of the ultrasound data, where such 3D data sets are accessed to present 3D images as described herein. The 3D images may be modified and the display settings of the display 318 also manually adjusted using the user interface 30.

A technical effect of at least one embodiment is utilize a correlation algorithm to improve image filtering. For example, the filtering in performed in such a way that the deformation field is taken into account to avoid smearing out edges in the images. The deformation field is taken into account by filtering along the motion field in each frame, so that the sharpness of moving structures are preserved. The temporal filter may be embodied as any type of filtering algorithm, such as for example, a linear finite-impulse filter, such as a Gaussian mask, an infinite-impulse filter, a nonlinear filter, such as a median filter, or some sort of anisotropic filter. In various embodiments, the intermediate images are generated by utilizing the deformation field to increase the image frame rate by computing intermediate frames that utilize the deformation field to limit blurring when computing a weighted average of two successive frames.

Various embodiments also perform global motion tracking by utilizing a single image patch in polar coordinates to correct for tilting of the ultrasound probe, since probe tilting/rotation corresponds to translations in raw polar data. The motion tracking may be used to detect subvolume stitching artifacts acquired during acquisition of ECG-gated 3D ultrasound.

It should be noted that although the various embodiments may be described in connection with an ultrasound system, the methods and systems described herein are not limited to ultrasound imaging or a particular configuration thereof. In particular, the various embodiments may be implemented in connection with different types of imaging, including, for example, magnetic resonance imaging (MM) and computed-tomography (CT) imaging or combined imaging systems. Further, the various embodiments may be implemented in other non-medical imaging systems, for example, non-destructive testing systems.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for performing motion compensated temporal filtering of a three-dimensional (3D) image dataset, said method comprising:
accessing with a processor a three-dimensional (3D) dataset comprising a plurality of images, the images including at least a first 3D image acquired at a first time and a different second 3D mage acquired at a second time;
determining a phase correlation between a patch in the first 3D image and a patch in the second 3D image;
generating a 3D displacement vector that represents a displacement between the patch in the first 3D image and the patch in the second 3D image; and
generating at least one 3D image using the 3D displacement vector.

2. The method of claim 1 further comprising:
dividing the first 3D image into a first plurality of patches;
dividing the second 3D image into a second plurality of patches that is equal in number to the first plurality of patches;
determining a phase correlation between a patch in the first 3D image and a patch in the second 3D image, the patches in the first and second 3D images having a same coordinate position; and
generating a plurality of displacement vectors based on the determined phase correlation.

3. The method of claim 1 further comprising using the 3D displacement vector to generate an interim 3D image, in real time, that represents motion of an object at a time period between the first and second times.

4. The method of claim 2 further comprising:
fitting the displacement vectors to a deformation field to generate displacement values; and
using the displacement values to generate an interim 3D image that represents motion of an object at a time period between the first and second times.

5. The method of claim 1 further comprising:
fitting the displacement vector to a deformation field;
using the deformation field to generate an interim image; and
combining the first and second 3D images with the interim image to generate a revised 3D dataset that has a second quantity of images that is greater than a first quantity of images in the 3D dataset.

6. The method of claim 1 further comprising using the displacement vector to filter the generated image in a manner that avoids smearing out edges of moving structures.

7. The method of claim 1 further comprising dividing the first and second 3D images into a plurality of image patches.

8. The method of claim 1 further comprising dividing the first and second 3D images into a plurality of overlapping image patches.

9. A non-transitory computer readable medium for performing motion compensated temporal filtering of a three-dimensional (3D) image dataset, said non-transitory computer readable medium programmed to:
access a three-dimensional (3D) dataset including plurality of images, the images including at least a first 3D image acquired at a first time and a different second 3D mage acquired at a second time;
determine a phase correlation between a patch in the first 3D image and a patch in the second 3D image;
generate a 3D displacement vector that represents a displacement between the patch in the first 3D image and the patch in the second 3D image; and
generate at least one 3D image using the 3D displacement vector.

10. The non-transitory computer readable medium of claim 9 further programmed to:
divide the first 3D image into a first plurality of patches;
divide the second 3D image into a second plurality of patches that is equal in number to the first plurality of patches;
determine a phase correlation between a patch in the first 3D image and a patch in the second 3D image, the patches in the first and second 3D images having a same coordinate position; and
generate a plurality of displacement vectors based on the determined phase correlation.

11. The non-transitory computer readable medium of claim 9 further programmed to use the 3D displacement vector to generate an interim 3D image, in real time, that represents motion of an object at a time period between the first and second times.

12. The non-transitory computer readable medium of claim 9 further programmed to:
fit the displacement vectors to a deformation field to generate displacement values; and
use the displacement values to generate an interim 3D image that represents motion of an object at a time period between the first and second times.

13. The non-transitory computer readable medium of claim 9 further programmed to:
fit the displacement vectors to a deformation field;
use the deformation field to generate an interim image; and
combine the first and second 3D images with the interim image to generate a revised 3D dataset that has a second quantity of images that is greater than a first quantity of images in the 3D dataset.

14. The non-transitory computer readable medium of claim 9 further programmed to use the displacement vectors to filter the generated image in a manner that avoids smearing out edges of moving structures.

15. The non-transitory computer readable medium of claim 9 further programmed to divide the first and second 3D images into at least one of a single image patch, a plurality of image patches, or a plurality of overlapping image patches.

16. An ultrasound system for performing motion compensated temporal filtering of a three-dimensional (3D) image dataset, said ultrasound system comprising:
an ultrasound probe; and
a processor coupled to said ultrasound probe, said processor programmed to:
access a three-dimensional (3D) dataset including plurality of images, the images including at least a first 3D image acquired at a first time and a different second 3D mage acquired at a second time;
determine a phase correlation between a patch in the first 3D image and a patch in the second 3D image;
generate a 3D displacement vector that represents a displacement between the patch in the first 3D image and the patch in the second 3D image; and
generate at least one 3D image using the 3D displacement vector.

17. The ultrasound system of claim 16 wherein said processor is further programmed to:
divide the first 3D image into a first plurality of patches;
divide the second 3D image into a second plurality of patches that is equal in number to the first plurality of patches;
determine a phase correlation between a patch in the first 3D image and a patch in the second 3D image, the patches in the first and second 3D images having a same coordinate position; and
generate a plurality of displacement vectors based on the determined phase correlation.

18. The ultrasound system of claim 16 wherein said processor is further programmed to use the 3D displacement vector to generate an interim 3D image, in real time, that represents motion of an object at a time period between the first and second times.

19. The ultrasound system of claim 16 wherein said processor is further programmed to:
fit the displacement vectors to a deformation field;
use the deformation field to generate an interim image; and
combine the first and second 3D images with the interim image to generate a revised 3D dataset that has a second quantity of images that is greater than a first quantity of images in the 3D dataset.

20. The ultrasound system of claim 16 wherein said processor is further programmed to use the displacement vectors to filter the generated image in a manner that avoids smearing out edges of moving structures.
